(19) United States
(12) Patent Application Publication
(10) Pub. No.: US 2007/0242607 A1
(43) Pub. Date: Oct. 18, 2007

(54) Method and system for controlling distribution of network topology information

(75) Inventors: Jonathan B. Sadler, Naperville, IL (US); Thomas Benjamin Mack-Crane, Downers Grove, IL (US)

Correspondence Address: THE SMALL PATENT LAW GROUP LLP, 611 OLIVE STREET, SUITE1611, ST. LOUIS, MO, 63101, US

(73) Assignee: Tellabs Operations, Inc.

(21) Appl. No.: 11/403,324

(22) Filed: Apr. 13, 2006

(51) Int. Cl. H04L 12/26

(52) U.S. Cl. 370/238

(57) ABSTRACT

In accordance with one aspect of the present invention, a network topology management system is provided for managing distribution of network topology information between nodes within a network that performs a distributed source routing protocol. The system includes, nodes distributed throughout a network, that are interconnected by node-to-node links, each of which is described by associated link state information. The system includes a control module that is joined to the nodes and that receives the link state information from each node. The control module records the link state information in master routing tables to form an overall topology map of the network. The control module stores predetermined policy statements that define a manner in which the link state information should be distributed between the nodes. The control module creates abridged routing tables by modifying the link state information based on the predetermined policy statements. The abridged routing tables differ from the master routing tables of the overall network topology map. The control module distributes the abridged routing tables to at least one of the nodes in the network. The control module may entirely mask a select link state such that an abridged routing table entirely excludes connectivity between a select node and a select neighboring node. The control module may modify link state attributes to form different first and second sets of abridged routing tables that are provided to different first and second nodes, respectively.

### BACKGROUND OF THE INVENTION

The present invention generally relates to distributed source routed networks and more particularly to methods and systems for controlling distribution of topology information between nodes within a distributed source routing network.

Data communications networks include a variety of network elements, such as computers, servers, nodes, routers, switches, bridges, clubs, proxies and other devices coupled to, and configured to pass data between, one another. In general, the data is formatted and passed as data units between the network elements through the use of one or more communication links and in accordance with a predetermined protocol, such as Internet Protocol packets, Ethernet frames, data cells, segments and other data formats. The network elements may have unique addresses (e.g., IP addresses) assigned thereto. A particular protocol for the data unit may be handled by multiple network elements and supported across multiple communications links as the data units are routed over the network between source and destination addresses.

Most protocols fall into one of two categories, namely Distance Vector protocols and Link State protocols. Distance vector protocols in general determine the distance between source and destination nodes by calculating the number of hops a packet traverses en route from the source node to the destination node. Distance vector protocols (e.g., Bellman-Ford algorithms) call for each node to send all or some portion of the node's routing table to the neighboring nodes. For each network path, the receiving node picks the neighboring nodes that exhibits the lowest cost and adds the neighboring nodes to its routing table for re-advertisement. Examples of distance vector protocols are RIP and RIP-2 algorithms. In general, Link State protocols send small updates throughout a network, while distance vector protocols send larger updates only to neighboring nodes. In distance vector protocols, the nodes know only about neighbors nodes. Link state protocols converge more quickly, and thus are somewhat less prone to routing loops than distance vector protocols. Also, while link state protocols have utilized more CPU power and memory as compared to distance vector protocols, link state protocols are generally more scalable than distance vector protocols.

Nodes within the network cooperate and communicate with one another to convey the data units between network elements. For example, an originating network element may provide a destination IP address to a source node. The source node uses the destination IP address, among other things, to calculate a route to another node that is joined to the network element having the destination IP address. The route traverses through one or more nodes within the network. In conventional source routing networks, the source node calculates the route based on routing tables that are stored at the source node. The routing tables define an overall network topology map for the network. Each node stores identical routing tables and thus each node has the same “view” of the overall network topology map. The source node may utilize various different metrics when implementing routing algorithms to determine the best route. Sophisticated routing algorithms can base route selection on multiple metrics.

Source routing, in general, represents techniques whereby a source node of a packet specifies a route that a packet should take through a network area as a packet travels through the network. In source routing, the source node in general makes some or all of the decisions as to which nodes a packet should travel through en route to the destination. In certain source routing implementations, the source node specifies the exact route along which the packet is to travel all the way to the destination IP address. In other source routing implementations, (e.g. lose source record routing (LSSR)), the source node provides one or more of the nodes through which the packet should travel, but not necessarily the entire path. Examples of link state algorithms include Open Shortest Path First (OSPF), intermediate system to intermediate system (IS-IS), and Netware's Link Services Protocol (NLSP).

In source routing algorithms, routing information is flooded to all nodes in the network in order that all nodes shall have an entire view of the overall network topology. As link states change, each node sends updated link state information, as link state advertisements, over the network to all other nodes. The link state advertisements describe the connectivity associated with the sending node. The link state information also includes link state attributes associated with each link state. Each node builds and maintains routing tables for the overall network topology map of the entire network.

However, existing distributed source routing implementations have experienced certain limitations. In conventional link state routing protocols in support of hop-by-hop routing, all nodes within a network must have a common overall network topology map in order to guarantee loop free routing. If each node was not provided with a common overall network topology map, routing loops would occur whereby nodes along a routing path might pass a data unit back to an upstream, preceding node that has already passed the same data unit. Thus, the data unit may fall into a never ending loop. To maintain the overall network topology map at each node, substantial detailed link state information is shared between all nodes. As link state information changes at a given node, the node updates the rest of the network on a dynamic basis through link state advertisements.

In certain environments, it may be undesirable to provide substantial detailed link state information about all nodes to one another. For example, different nodes within a network may be owned, managed or controlled by different entities (e.g., service providers and the like). Therefore, once each node constructs an overall network topology map, the entity that controls the node will have access to detailed link state information about the network capabilities of another entity. As another example, when capacity is being added to a network, it may be desirable to limit access initially the added capacity. For example, when new nodes, more bandwidth, new links (e.g. additional fiber connections) and the like are added to a network, it may be desirable to test fully the added capacity before making such capacity fully available to the network. Heretofore, when capacity was added to a network, the capacity was placed on the network all at one time, namely the capacity was either entirely unavailable or entirely available to all routing control elements in the network.

A need remains for improved methods and systems for controlling distribution of network topology information between nodes of a network that utilize a distributed source routing protocol.

### BRIEF DESCRIPTION OF THE INVENTION

In accordance with one aspect of the present invention, a network topology management system is provided for managing distribution of network topology information between nodes within a network that performs a distributed source routing protocol. The system includes nodes, distributed throughout a network, that are interconnected by node-to-node links, each of which is described by associated link state information. The system includes a control module that is joined to the nodes and that receives the link state information from each node. The control module records the link state information in master routing tables to form an overall topology map of the network. The control module stores predetermined policy statements that define a manner in which the link state information should be distributed between the nodes. The control module modifies the link state information to form modified link state information that yields abridged routing tables based on the predetermined policy statements. The abridged routing tables differ from the master routing tables of the overall network topology map. The control module distributes the modified link state information to at least one of the nodes in the network.

Optionally, the control module may produce multiple different sets of abridged routing tables, were each set of abridged routing tables forms a unique abridged network topology map that differs from other abridged network topology maps and that differs from the overall network topology map. The link state information may include link states and link state attributes, at least one of which is modified by the control module to create the abridged routing tables. Optionally, the control module may entirely mask a select link state such that an abridged routing table entirely excludes connectivity between a select node and a select neighboring node. Optionally, the control module may modify link state attributes to form different first and second sets of abridged routing tables that are provided to different first and second nodes, respectively, such that the first and second nodes have different link state information associated with a common select link state.

In accordance with an alternative embodiment, a method is provided for controlling distribution of topology information in a network that utilizes a source routing. The method includes receiving link state information associated with links between nodes within a network and recording the link state information in master routing tables to form an overall network topology map of links within the network. The method includes modifies the link state information to form modified link state information that yields abridged routing tables based on predetermined policy statements, wherein abridged routing tables differ from the master routing tables of the overall network topology map. The method further includes distributing the modified link state information to at least one node in the network.

### BRIEF DESCRIPTION OF THE DRAWINGS

FIG. 1 illustrates a block diagram of a communications network that is formed in accordance with an embodiment of the present invention.

FIG. 2 illustrates a block diagram of a network topology management hub and nodes joined thereto in accordance with an embodiment of the present invention.

FIG. 3 illustrates a portion of a policy statement that is constructed in accordance with an embodiment of the present invention.

FIG. 4 illustrates a block diagram of an alternative communications network that is formed in accordance with an embodiment of the present invention.

FIG. 5 illustrates a processing sequence carried out by a topology management hub in accordance with an embodiment of the present invention.

FIG. 6 illustrates a block diagram of a control module formed in accordance with an embodiment of the present invention.

### DETAILED DESCRIPTION OF THE INVENTION

The following detailed description sets forth certain examples to provide an understanding of embodiments of the present invention. The functions described herein may be implemented as a set of program instructions that are stored in a computer readable memory within one or more network elements and executed on one or more processors within the network elements. It is also understood that the various functions described herein may be implemented using integrated circuitry, such as application-specific integrated circuits (ASIC), programmable logic used in conjunction with a programmable logic device such as a field programmable gate array (FPGA), microprocessor, state machine or any other device including any combination thereof. Programmable logic may be fixed temporarily or permanently in a tangible medium such as in a read-only memory, random-access memory, a memory stick or other storage medium. Programmable logic may also be fixed in a computer data signal embodied in the carrier wave, allowing the programmable logic to be transmitted over an interface such as a computer bus or communications network.

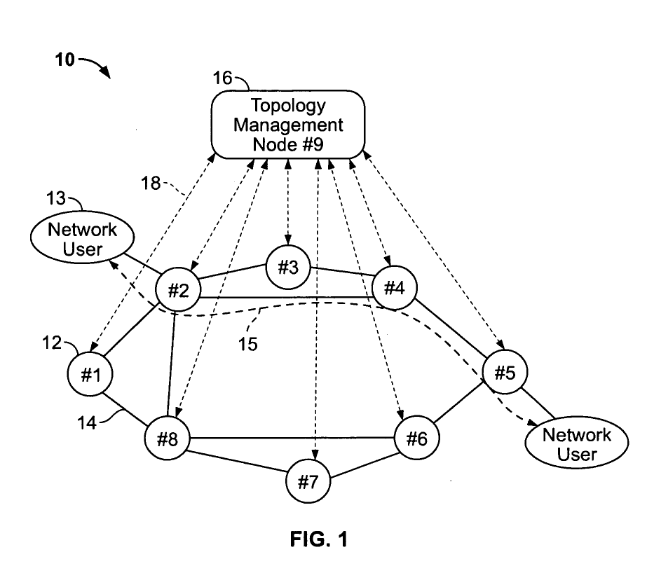

FIG. 1 illustrates a block diagram of a portion of a communications network 10 that is formed in accordance with an embodiment of the present invention. The network 10 includes a plurality of nodes 12 that are connected to one another through user data links 14 in a mesh topology at the user level or plane. The term “mesh topology” refers to many-to-one connectivity that provides a multiplicity of paths through the network 10. For convenience, each node 12 has been provided a unique number (e.g. #1 to #9). At least a portion of the nodes 12 communicate with network users 13 to provide points of ingress and egress to the network 10. Each node 12 presents one or more network elements that form network 10. The nodes 12 convey user traffic between one another and between network users 13 (such as between the network users 13 joined to nodes #5 and #2) based on a predetermined protocol. The user traffic is passed over a route (such as denoted by dashed line 15) that is determined based on a source routing algorithm. The route 15 may be calculated entirely by the node #5. Alternatively, the route 15 may be calculated partially by node #5 (which represents the source node 12) and partially by one or more intermediate nodes 12 (e.g., node #4). By way of example, user traffic may include data packets, TDM time slots, FDM channels, CDMA code, and the like.

The network 10 also includes a control topology (e.g. a hub topology) at the control level or plane. The control topology is shown by the dotted lines 18 between each of the nodes 12 and a designated topology management module 16. In FIG. 1, each node 12 is connected with a topology management module 16 over control links 18. Alternatively, the topology management module 16 may be located on a node 12 in the user plane. The topology management module 16 also controls distribution of topology information about the network to the nodes 12. The hub configuration of FIG. 1, is one example of a topology management module. The function of the topology management module 16 may be contained within a single computing nodes 12, or may be distributed amongst a number of nodes 12. Optionally, the control topology may be a dual hub topology. The topology management module 16 and nodes 12 may be connected by relatively high bandwidth resources, such as over the Internet or public switched telephone network (PSTN). The nodes 12 and module 16 may communicate with one another using wired links, infrared links, optical links, wireless links and the like. Communications between the nodes 12 may utilize various communications protocols, such as, for wireless links, the IEEE 802.16x protocols, the Universal Mobile Telecommunications System (UMTS) wireless communications protocol, the IEEE 802.11a protocol, the 802.18 protocol and the like.

The nodes 12 establish connectivity over the links 14, wherein each connection is defined by a link state and a series of link state attributes (collectively “link state information”). The link state attributes are utilized as various metrics by the source routing algorithm in connection with calculating routes through the network 10. For example, the following link state attributes may be used, namely path length, reliability, routing delay, bandwidth, load, communication cost, geographic location, diversity routing and the like. “Path length” is a common routing metric. Some routing protocols allow network administrators to assign arbitrary costs to each network link, in which case path link represents the sum of the costs associated with each link traversed. Other routing protocols define hop count, a metric that specifies the number of passes through internetworking nodes that a packet takes en route from a source to a destination. “Reliability” refers to the dependability (usually described in terms of the bit-error rate) of each network link. Some network links might go down more often than others. When a network fails, certain network links might be repaired more easily or more quickly than other links. Reliability factors may be taken into account in the assignment of the reliability ratings, which are arbitrary numeric values usually assigned to network links by network administrators. “Routing delay” refers to the length of time required to move a packet from source to destination through the network. Delay depends on many factors, including the bandwidth of intermediate network links, the port queues at each router along the way, network congestion on all intermediate network links, and the physical distance to be traveled. Because delay is a conglomeration of several important variables, it is a common and useful metric.

“Bandwidth” refers to the available traffic capacity of a link. For example, all other things being equal, a 10-Mbps Ethernet link would be preferable to a 64-kbps leased line. Although bandwidth is a rating of the maximum attainable throughput on a link, routes through links with greater bandwidth do not necessarily provide better routes than routes through slower links. For example, if a faster link is busier, the actual time required to send a packet to the destination could be greater. “Load” refers to the degree to which a network resource, such as a router, is busy. Load can be calculated in a variety of ways, including CPU utilization and packets processed per second. Monitoring these parameters on a continual basis can be resource-intensive itself. “Communication cost” may be used, such as when certain companies may not care about performance as much as they care about operating expenditures. Although line delay may be longer, a company may choose to send packets over their own lines rather than through the public lines that cost money for usage time.

Once the nodes 12 establish the connections over the links 14, the nodes 12 supply link state information to the topology management module 16 over the control link 18. The link state information includes, among other things, the link state and the link state attributes associated with each link 14. The topology management module 16 receives link state information, such as link states and link state attributes) that is associated with each link 14 between nodes 12 within the network 10. The link states and link state attributes collectively, define an overall topology view of the network. The topology management module 16 combines the link state information to form a set of master routing tables that define an overall network topology map. The topology management module 16 also stores a table of predetermined policy statements. The policy statements include a series of rules that are associated with select nodes, link states and link state attributes. The rules filter or regulate distribution of the link state information to the nodes 12. The module 16 uses the policy statements to modify the link state information to form modified link state information that yields or create sets of abridged routing tables, where each set of abridged routing tables differs from one another and from the master routing tables. The abridged routing tables may be constructed at the module 16 before distribution to the nodes 12. Alternatively, the module 16 may distribute the modified link state information to the nodes 12 that then construct the abridged routing tables. In both of the above examples, the modified link state information “yields” the abridged routing tables regardless of whether the abridged routing tables are constructed at the module 16 or at the node 12. The topology management module 16 distributes the abridged routing tables or modified link state information to the nodes 12 in the network 10 based on the policy statements.

When the module 16 creates multiple different sets of abridged routing tables, each abridged routing table provides different “view” of link state information to a corresponding node. The module 16 may create a set of abridged routing tables by modifying link state information associated with a select node 12. The module 16 may also create an abridged routing table by entirely masking one or more link states such that the abridged routing table excludes entirely one or more node-to-node links associated with the masked link state.

The nodes 12 convey data units between one another based on source routing calculations. Each node 12 performs source routing calculations based on the abridged routing tables that are stored locally at the node 12.

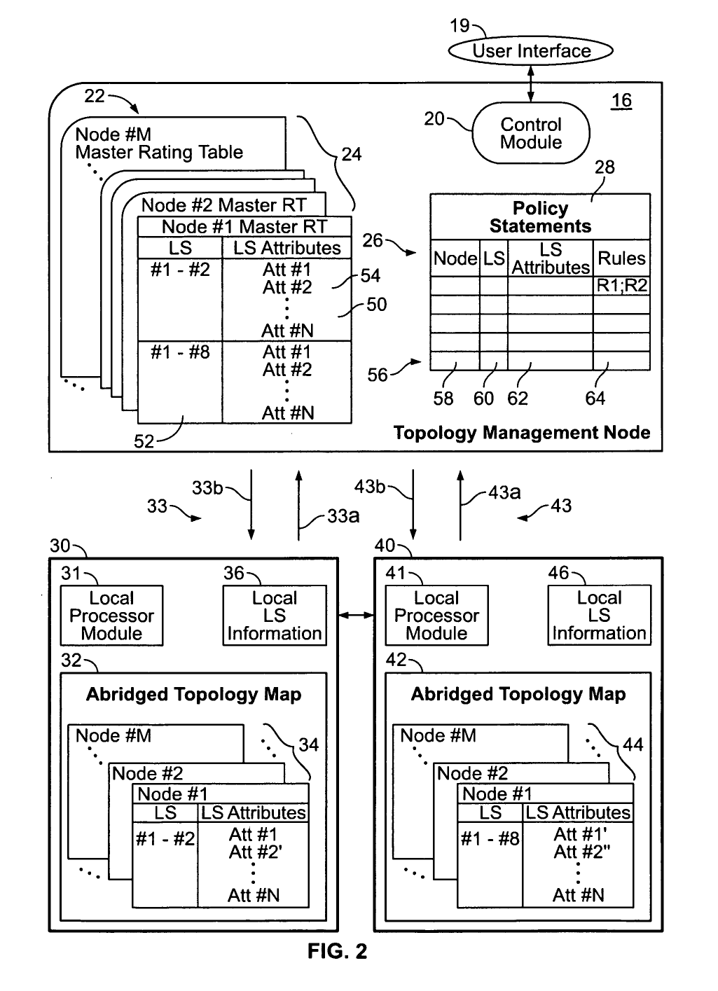

FIG. 2 illustrates a block diagram of the module 16 and two nodes 12. The module 16 includes a control module 20, a user interface 19, memory 22 for storing an overall network topology map 24 and memory 26 for storing a table of policy statements 28. The control module 20 may perform the same functions as any other node 12. The control module 20 also controls distribution of link state information to and from the individual nodes 12. The module 16 communicates with an individual node 30 over link 33 and with an individual node 40 over link 43. The link 33 includes in-coming path 33a and outgoing path 33b, while the link 43 includes in-coming path 43a and outgoing path 43b. The nodes 30 and 40 include local processor modules 31 and 41, and memory 32 and 42. The memory 32 and 42 stores abridged routing tables that define corresponding abridged topology maps 34 and 44 the local processor modules 31 and 41 establish connectivity with neighboring nodes 12, and based thereon determine the local link state information 46 associated with each link 14 (FIG. 1). The local processor modules 31 and 41 store the local link state information 36 and 46, respectively, associated with connections joined directly to the corresponding nodes 30, 40. The local link state information 36 and 46 identifies each link state directly joined to the corresponding node 30 and 40, as well as values for the link state attributes associated with each link state. The nodes 30 and 40 provide the local link state information 36 and 46 over the in-coming paths 33a and 43a to the module 16.

The control module 20, records the link state information from each node 12 in the master routing tables to construct an overall network topology map 24. The overall network topology map 24 may be formed as a series of routing tables 50, each routing table 50 of which is associated with a corresponding node 12. Each routing table 50 may include a link state field 52 for link states, over which connections have been established, for a node 12.

In the example of FIG. 2, the routing table 50 associated with node #1 includes a link state between nodes #1 and #2, and a link state between nodes #1 and #8. While not shown, the routing table 50 also includes a link state between nodes #1 and #9 in the implementation in which the module 16 also functions as a node #9. The control module 20 also records, within the routing table 50, link state attributes in link state field 54 associated with each link state. In the example of FIG. 2, each link state may have up to N link state attributes. The control module 20 records each link state attribute ATT #1 to ATT #N for the link state #1-#2, and records link state attributes ATT #1 to ATT #N for the link state #1-#8. The control module 20 also records routing tables for each of nodes #2 to node #M, that collectively define the overall network topology map 24.

The module 16 stores, in memory 26, a table of policy statements 28. The policy statements 28 are used by the control module 20 in connection with controlling distribution of link state information from the routing tables 50 to nodes 12. The policy statements 28 may be provided in a variety of forms. In the example of FIG. 2, the policy statements 28 may constitute rules 56. Each rule 56 includes a node field 58, one or more link state fields 60, one or more link state attribute fields 62, and one or more rule fields 64. The node field 58 identifies a source node having the connectivity with neighboring nodes that are identified in the link state field 60 and link state attribute field 62. The link state field 60 and link state attribute field 62 identify particular link states and link state attributes associated with a node in the node field 58, to which the rule(s) within rule field 64 are to be applied.

In the example of FIG. 2, the control module 20 may provide an automated system for modifying routing tables. Alternatively, the control module 20 may include a user interface 19 that permits an operator having certain administrative privileges to individually modify routing tables by changing link state attributes, by masking link states and the like. For example, the control module 20 may automatically (or under control of an administrator) change weights associated with particular links 14 based on traffic patterns, such as to balance traffic at times of high demand.

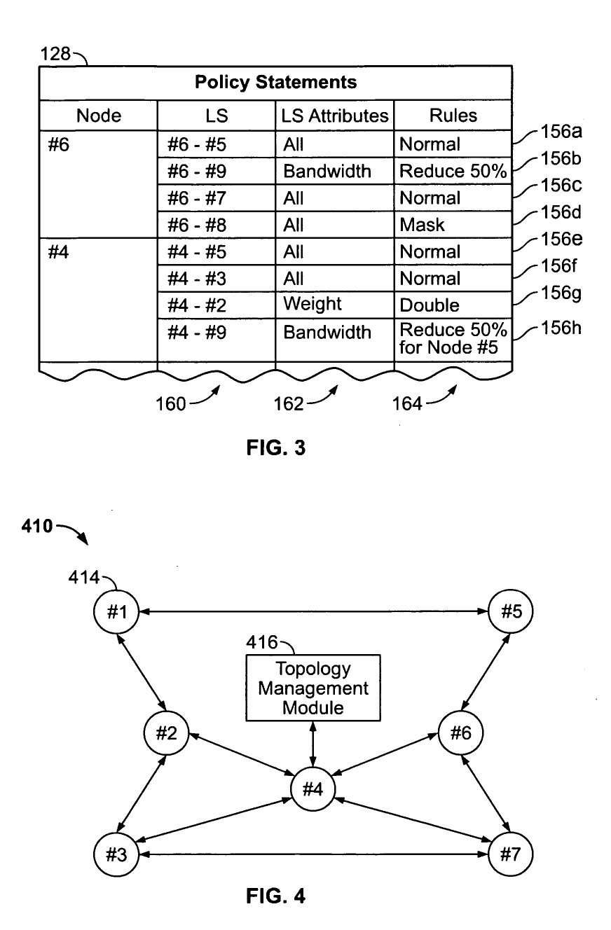

FIG. 3 illustrates exemplary policy statements 128 that may be utilized by the control module 20 (FIG. 2) in connection with nodes #6 and #4. In the example of FIG. 3, the link state field 160 identifies each link state that has been established for node #6 and node #4, while the link state attribute field 162 identifies each link state attribute that has been established for node #6 and node #4. The policy statement 128 includes rules 150a-156h, each of which corresponds to a unique combination of link state attributes and link states. Rule 156a corresponds to the link state between nodes #6 and #5 and all of the associated link state attributes. Rule 156a indicates that all link state attributes associated with link state #6-#5 are to be passed, by the control module 20, in a normal unmodified manner to all nodes 12 within the network 10. Similarly, rules 156c, 156e, and 156f indicate that all link state attributes associated with link states #6-#7, #4-#5, and #4-#3, respectively, are to be passed in a normal unmodified manner to all nodes 12.

The rules 156b, 156g and 156h provide examples of how the policy statements 128 may be utilized to modify link state information from the original form and provide the modified link state information to the nodes 12. Rule 156b indicates that the link state attribute associated with bandwidth for the link state #6-#9 is to be modified or abridge from an actual value or condition to reduce by 50% the indicated bandwidth capacity of the corresponding link state. Thus, rule 156b directs the control module 20 to create a “pseudo value” for the bandwidth attribute of the link state #6-#9. For example, if the full bandwidth capacity of link state #6-#9 represents 10 Mbps, the control module 20 will abridge the actual bandwidth information and instead inform each node 12 within the network 10 that the pseudo bandwidth capacity associated with links state #6-#9 is only 5 Mbps.

Rule 156g instructs the control module 20 to modify the link state attribute, associated with the weight or cost of link state #4-#2, from an actual value by doubling the weight associated with the link state to a pseudo value. For example, if the actual weight associated with link state #4-#2 represented 100, the control module 20 abridges the weight information and informs each node 12 within the network 10 that the pseudo weight associated with link state #4-#2 was 200.

Rule 156d provides an example for when it may be desirable to entirely hide or mask connectivity between two nodes. Rule 156d corresponds to the link state #6-#8 between nodes #6 and #8, and instructs the control module 20 to entirely hide or mask from all other nodes 12 the existence of the link state #6-#8. Returning to FIG. 1, an “X” has been provided over the link 14 between nodes #6 and #8 to indicate that this link 14 is to be masked. Hence, none of nodes #1-5 and #7 are aware or informed of the link between nodes #6 and #8. Node #8 is aware of the link to node #6 because node #8 is directly joined to node #6.

Optionally the rules within rule field 164 may be correlated, not just too specific link state attributes within link state attribute field 162. In addition, the specific rules may be directly correlated to target nodes that are to receive an abridged routing table. For example, rule 156h instructs the control module 20 to reduce by 50% the bandwidth attribute associated with link state #4-#9 before providing the bandwidth attribute to target node #5. In this example, all other nodes #1-#3 and #6-#9 are informed of the full bandwidth capability of the link state #4-#9. Only node #5 is provided with pseudo bandwidth information, namely a 50% reduction from the actual bandwidth value. Rule 156h is specific to a desired target node #5. Thus, the target node #5 will have a different “view” or different link state information than other nodes (e.g., nodes #1-#4 and #6-#9).

FIG. 4 illustrates a network 410 having an alternative topology architecture that may be implemented in accordance with an embodiment of the present invention. The network 410 includes nodes 414 that are configured to operate in a user plane and are joined by user links 414. The network 410 also includes a topology management module 416. The topology management module 416 does not necessarily operate as a hub or within the user plane as do nodes 414. Instead, the topology management module 416 communicates with one node 414 (node #4) that has been designated to operate as a gateway for collecting link state information and distributing abridged network topology maps. The node #4 receives link state information from each of nodes #1-#3 and #5-#7 and provides the link state information to the topology management module 416. The topology management module 416 constructs master routing tables for an overall network topology map 24 (FIG. 2) and, based upon policy statements 28, distributes one or more sets of abridged routing tables as abridged network topology maps to the nodes 414. Each abridged network topology map is provided with header information identifying the destination node 414. When a node 412 receives an abridged network topology map addressed to the node 412, the node 412 stores the abridged network topology map. Otherwise, the node 412 passes the abridged network topology map onto the other nodes 412.

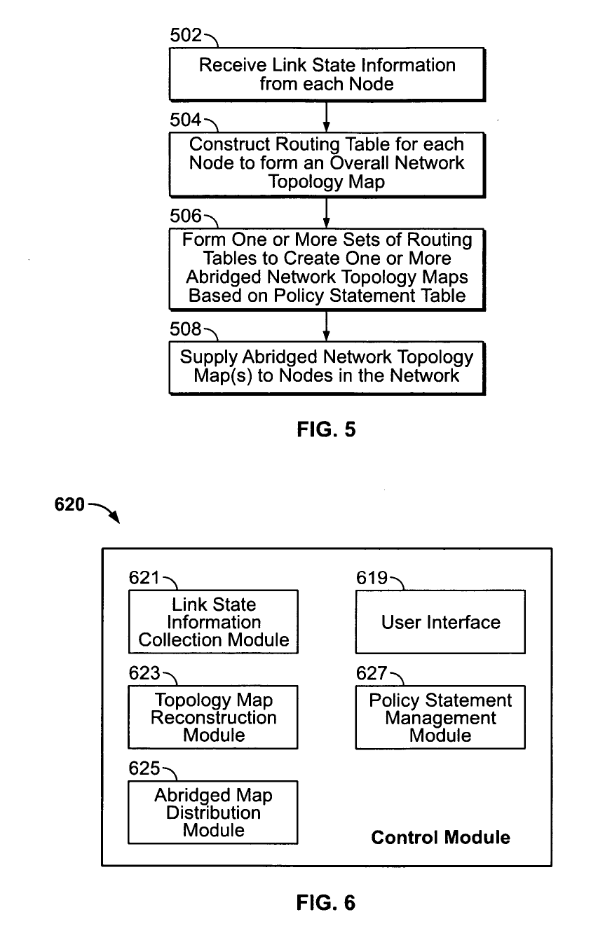

FIG. 5 illustrate a block diagram of the processing sequence carried out by the module 16 or module 416 in accordance with embodiments of the present invention. Beginning at 502, the control module 20 receives link state information from each node within the network. The link state information includes all link states and associated link state attributes for a corresponding node. At 504, the control module 20 constructs a master routing table associated with each node to form a set of master routing tables for an overall network topology map. At 506, the control module 20 accesses the table of policy statements 28 and compares the rules 56 within each policy statement 28 with the corresponding master routing table 50. The control module 20 forms sets of abridged routing tables 32, 42 to construct one or more abridged network topology maps based on the policy statements 28. A common abridged network topology map may be formed by the topology control module 20 for all nodes 12. Alternatively, different abridged network topology maps may be formed in connection with individual nodes 12 or groups of nodes 12. At 508, the control module 20 outputs one or more sets of abridged routing tables 32, 42 to the nodes 12.

FIG. 6 illustrates a block diagram of a control module 620 formed in accordance with an embodiment of the present invention. The control module 620 includes a user interface 619 that permits an operator to, among other things, enter policy statements, monitor the overall and abridged topology maps and the like. The control module 620 also includes a link state information (LSI) collection module 621, a topology map reconstruction module 623, an abridged map distribution module 625 and a policy statement management module 627. The modules 621-627 performed the functions described above in connection with FIGS. 1-5. It is understood that each of the modules 621-627 may be constructed in various hardware and/or software forms, such as by separate software modules or instructional threads performed in parallel by a common processor or parallel processors.

The LSI collection module 621 communicates with the nodes 12 (FIG. 1) to obtain link state information there from. The LSI collection module 621 organizes and formats the link state information and records the link state information in memory 22 within the corresponding routing table 50 (FIG. 2) to define the overall network topology map 24. The policy statement management module 627 controls access to, and updates of, the policy statements 28 in memory 26. Optionally, the policy statement management module 627 may automatically update and maintain the policy statements 28. Alternatively, the policy statement management module 627 may operate under the direction of an operator, via the user interface 619, to update and manage the policy statements 28.

The topology map reconstruction module 623 accesses the policy statements 28 in memory 26, as well as the routing tables 50 in memory 22, to form the modified link state information that is utilized to construct the abridged topology maps 34 and 44 (FIG. 2). The topology map reconstruction module 623 leaves unchanged, modifies and/or removes link states and link state attributes, as explained above, based on the corresponding policy statements. The topology map reconstruction module 623 may store the abridged topology maps locally at the topology management node (such as in memory 22 or memory 26). Alternatively, the topology map reconstruction module 623 may pass the abridged topology maps directly to the abridged map distribution module 625 for immediate distribution to one or more associated nodes 12. When the abridged topology maps are locally stored at the topology management node 16, the abridged map distribution module 625 accesses the corresponding memory 22, 26 to distribute the abridged topology maps to one or more associated nodes 12.

In accordance with certain of the above embodiments, methods and systems are provided in which links states and/or link state attributes may be hidden and are modified, such as to limit traffic over a particular blank. In accordance with certain of the above embodiments, a hub topology is provided to allow control over the distribution of links state information, thereby providing the ability to prevent a link from being reported, two modify links state information and the like. In accordance with certain embodiments, carriers are afforded the ability to control traffic over all or a portion of the network, to prevent certain links from being used, to limit the sharing of information about a particular carriers network topology and the like.

Optionally, the policy statements 28 may be recorded in a form other than a table. Also, the rules may be organized in a manner other than in connection with particular link states and link state attributes. For example, a rule may be associated with a group of link states and/or a group of link state attributes. Further, the rules may be associated with destination nodes, as opposed to a source node. For example, a rule may provide that a particular node (to receive a set of abridged routing tables) is not to be provided certain link state attribute information, independent of the source node with which the link state attributes originated. As a further example, the rules may be organized into classes or levels of priority. For example, the nodes 12 may be classified in different levels, where each level is entitled to abridged routing tables having a different level of detail regarding the link state information of other nodes.

While the above examples are provided in connection with meshed topologies, it is understood that other topologies may be utilized. It is understood that the embodiments described above may be implanted using various routing protocols, such as the OSPF protocol, the intermediate system to intermediate system intra-domain routing exchange protocol and the like.

While the above embodiments are described in connection with link state protocols used during source routing, the present invention may be utilized with non-link state protocols utilized during source routing. For example, the present invention may be used with path vector protocols (e.g., distance vector protocols that include path information) utilized during source routing. The path information includes link state information for a series of links interconnecting nodes used to reach a destination. Similar to the embodiments discussed above, the path information would be used to construct master overall distribution tables.

For example, similar to the process of FIG. 5, the path information includes all link states and associated link state attributes for a series of links used to reach a destination. The control module constructs a master routing table associated with each node to form a set of master routing tables for an overall network topology map. The control module accesses the table of policy statements and compares the rules within each policy statement with the corresponding master routing table. The control module forms sets of abridged routing tables to construct one or more abridged network topology maps based on the policy statements. The control module outputs one or more sets of abridged routing tables to the nodes.

While the invention has been described in terms of various specific embodiments, those skilled in the art will recognize that the invention can be practiced with modification within the spirit and scope of the claims.

What is claimed is:

1. A method for controlling distribution of topology information in a network utilizing source routing, comprising:
recording link state information, associated with links between nodes within a network, in master routing tables to form an overall network topology map of links within the network;
modifying the link state information based on predetermined policy statements to form modified link state information that yields abridged routing tables differing from the master routing tables of the overall network topology map; and
distributing the modified link state information to at least one node in the network.

2. The method of claim 1, wherein the modifying creates multiple different sets of abridged routing tables, each set of abridged routing tables forming a unique abridged network topology map that differ from one anther and from the overall network topology map.

3. The method of claim 1, wherein the link state information includes link states and link state attributes and wherein the modifying modifies at least one link attribute in the master routing tables to create the abridged routing tables.

4. The method of claim 1, wherein the link state information includes link state attributes corresponding to at least one of bandwidth, weight, load, path length, adaptation, geographic location and quality of service related to a link between two nodes, and wherein the modifying modifies a value of the link state attribute from an actual value to a pseudo value.

5. The method of claim 1, wherein the link state information includes a select link state identifying connectivity between the select node and a select neighboring node that is directly connected to the select node, and wherein the modifying includes masking the select link state such that the abridged routing tables exclude the connectivity between the select node and the select neighboring node.

6. The method of claim 1, wherein the link state information includes a select link state identifying connectivity between the select node and a select neighboring node that is directly connected to the select node, and wherein the modifying forms first and second sets of abridged routing tables that describe different first and second sets of link states, the first set of abridged routing tables including the select link state, the second set of abridged routing tables excluding the select link state.

7. The method of claim 1, further comprising storing the abridged routing tables at a corresponding node in a link state database.

8. The method of claim 1, further comprising computing, at a node, a source routing path based on the abridged routing tables provided to the node.

9. The method of claim 1, wherein the predetermined policy statements include rules associated with nodes and the link state information, one of the rules identifying link state information associated with a select node that is to be masked from other nodes in the network.

10. The method of claim 1, wherein the predetermined policy statements include rules associated with nodes and the link state information, one of the rules identifying link state information associated with a select node that is to be modified from an original form before being provided to other nodes in the network.

11. A network topology management module configured to communicate with a network of distributed nodes that are interconnected by node-to-node links, each node-to-node link having link state information associated therewith, the management module comprising:
memory storing master routing tables and predetermined policy statements; and
a control module receiving link state information associated with the node-to-node links, the control module recording the link state information in the master routing tables to form an overall topology map of the network, the control module modifying the link state information based on the predetermined policy statements to form modified link state information that yields abridged routing tables differing from the master routing tables of the overall network topology map, the control module distributing the modified link state information to at least one of the nodes in the network.

12. The system of claim 11, wherein the control module further comprises a topology map reconstruction module for producing multiple different sets of abridged routing tables, each set of abridged routing tables forming a unique abridged network topology map that differ from one anther and from the overall network topology map.

13. The system of claim 11, wherein the link state information includes link states and link state attributes and wherein the control module modifies at least one link state attribute in the master routing tables to create the abridged routing tables.

14. The system of claim 11, wherein the link state information includes link state attributes corresponding to at least one of bandwidth, weight, load, path length, adaptation, geographic location and quality of service related to a link between two nodes, and wherein the control module modifies a value of the link state attribute from an actual value to a pseudo value.

15. The system of claim 11, wherein the link state information includes a select link state identifying connectivity between the select node and a select neighboring node that is directly connected to the select node, and wherein the control module masks the select link state such that the abridged routing tables exclude the connectivity between the select node and the select neighboring node.

16. The system of claim 11, wherein the link state information includes a select link state identifying connectivity between the select node and a select neighboring node that is directly connected to the select node, and wherein the control module forms first and second sets of abridged routing tables that describe different first and second sets of link states, the first set of abridged routing tables including the select link state, the second set of abridged routing tables excluding the select link state.

17. The system of claim 11, wherein the control module further comprises an abridged map distribution module for conveying the abridged routing tables to a corresponding node that stores the abridged routing table in a link state database.

18. The system of claim 11, wherein the node computes a source routing path based on the abridged topology view.

19. The system of claim 11, wherein the predetermined policy statements include rules associated with nodes and the link state information, and the control module includes a topology map reconstruction module for masking link state information associated with a select node that is to be masked from other nodes in the network based on one of the rules.

20. The system of claim 11, wherein the predetermined policy statements include rules associated with nodes and the link state information, and the control module includes a topology map reconstruction module for modifying link state information associated with a select node from an original form before providing the modified link state information to other nodes in the network based on one of the rules.
